(19) United States
(12) Patent Application Publication
(10) Pub. No.: US 2023/0340202 A9
(43) Pub. Date: Oct. 26, 2023

(54) Polyamideimide Film-Forming Composition, Method of Preparing the Same, and Use Thereof

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR)

(21) Appl. No.: 17/941,104

(22) Filed: Sep. 9, 2022

(30) Foreign Application Priority Data
Sep. 10, 2021 (KR) 10-2021-0120938
Sep. 10, 2021 (KR) 10-2021-0121050

(51) Int. Cl. C08G 73/14; C08G 69/32; C08K 3/36; C08K 3/013; C08F 222/10; C08J 5/18

(52) U.S. Cl. CPC C08G 73/14; C08G 69/32; C08K 3/36; C08K 3/013; C08F 222/1006; C08J 5/18; C08K 2201/003; C08K 2201/011; C08J 2379/08

(57) ABSTRACT

The present disclosure relates to a polyamideimide film-forming composition, a method of preparing the same, and a use thereof. The polyamideimide film-forming composition according to one embodiment prevents deterioration of colorless and transparent optical properties and has excellent mechanical properties, and thus may be effectively used for a polyamideimide film or a display device including the polyamideimide film.

### CROSS-REFERENCE TO RELATED APPLICATIONS

This application claims priority to Korean Patent Application No. 10-2021-0120938, filed Sep. 10, 2021, and Korean Patent Application No. 10-2021-0121050, filed Sep. 10, 2021 in the Korean Intellectual Property Office, the disclosures of which are hereby incorporated by reference in their entireties.

### BACKGROUND OF THE INVENTION

### Field of the Invention

The following disclosure relates to a polyamideimide film-forming composition, a method of preparing the same, and a use thereof.

### Description of Related Art

A polyamideimide film, which is a material for a substrate and a cover window of a display device, is attracting attention as a next-generation material that may replace tempered glass. However, in order to apply the polyamideimide film to the display device, it is essential to improve an intrinsic yellow index and impart colorless and transparent performance. Furthermore, in order to apply the polyamideimide film to a foldable or flexible display device, it is required for the polyamideimide film to be accompanied by improvement of mechanical properties. Therefore, required performance of the polyamideimide film for a display device has been gradually enhanced.

To this end, studies to reduce a charge transfer complex (CTC) effect by combining or changing monomers having various structures have been continuously conducted, but there is a limit in that a residual yellow color is still exhibited and a yellow index is increased as a thickness of the film is increased. In addition, although a method of adding an additive to the polyamideimide film has been proposed, it is difficult to use the method due to problems in the manufacturing process, and there is a limit to solving deterioration of the excellent mechanical properties inherent in polyamideimide even though transparency is secured.

Therefore, in order to apply the polyamideimide film to various display device material fields including a replacement material for a cover window of a display device as well as a substrate, there is a need for development of a technology for a polyamideimide film that has a wider application range by preventing deterioration of intrinsic excellent mechanical properties, simultaneously satisfying transparency and mechanical properties, and having excellent optical properties.

### SUMMARY OF THE INVENTION

An embodiment of the present disclosure is directed to providing a polyamideimide film-forming composition that prevents deterioration of colorless and transparent optical properties, has no optical stains, and has excellent visibility and excellent heat resistance and mechanical properties.

Another embodiment of the present disclosure is directed to providing a method of preparing a polyamideimide film-forming composition that prevents deterioration of colorless and transparent optical properties, has no optical stains, and has excellent visibility and excellent heat resistance and mechanical properties.

Still another embodiment of the present disclosure is directed to providing a polyamideimide film obtained by curing the polyamideimide film-forming composition, and a cover window for a display device or a display device including the same.

In one general aspect, a polyamideimide film-forming composition contains: polyamic acid or polyamideimide including a diamine-derived structural unit, a dianhydride-derived structural unit, and a diacid dichloride-derived structural unit; and an additive,

wherein the additive contains inorganic nanoparticles, a polyfunctional (meth)acrylic compound, and one or more of blue-based pigments and dyes, the inorganic nanoparticles are contained in an amount of 5 wt % to 40 wt % with respect to a solid content in the polyamic acid or the polyamideimide, the polyfunctional (meth)acrylic compound is contained in an amount of 2 wt % to 10 wt % with respect to the solid content in the polyamic acid or the polyamideimide, and

the diamine-derived structural unit includes a structural unit derived from a compound represented by the following Chemical Formula 1, the dianhydride-derived structural unit includes a structural unit derived from a compound represented by the following Chemical Formula 2, and the diacid dichloride-derived structural unit includes a structural unit derived from one or more of a compound represented by the following Chemical Formula 3 and a compound represented by the following Chemical Formula 4:

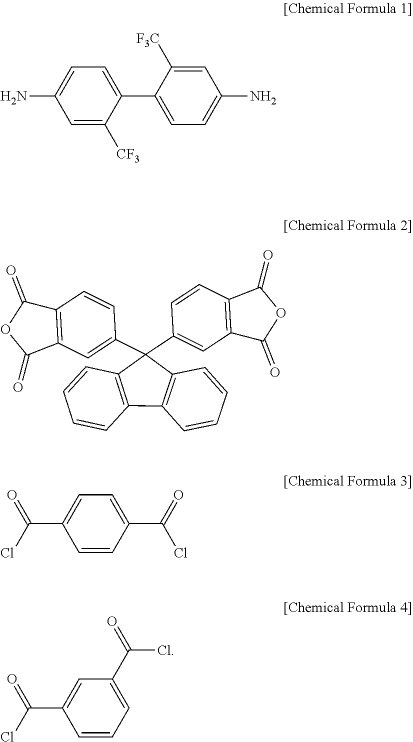

In another general aspect, a method of preparing a polyamideimide film-forming composition includes:

preparing a reaction product of a diamine and a diacid dichloride;

preparing a polyamic acid solution by adding the reaction product of the diamine and the diacid dichloride and a dianhydride to a reaction medium containing one or more of blue-based pigments and dyes and allowing a reaction to proceed; and

adding, to the polyamic acid solution, inorganic nanoparticles in an amount of 5 wt % to 40 wt % with respect to a solid content in polyamic acid or polyamideimide and a polyfunctional (meth)acrylic compound in an amount of 2 wt % to 10 wt % with respect to the solid content in the polyamic acid or the polyamideimide,

wherein the diamine contains a compound represented by the following Chemical Formula 1, the dianhydride contains a compound represented by the following Chemical Formula 2, and the diacid dichloride contains one or more of a compound represented by the following Chemical Formula 3 and a compound represented by the following Chemical Formula 4:

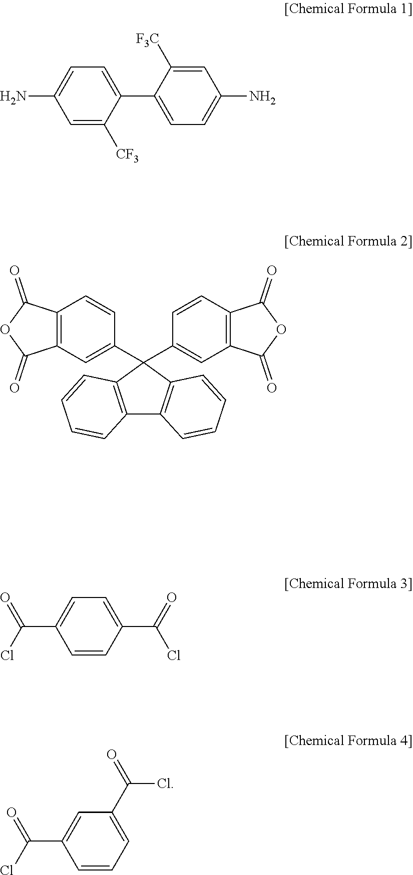 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

In still another general aspect, there is provided a polyamideimide film obtained by curing the polyamideimide film-forming composition according to any one of the embodiments.

In still another general aspect, a cover window for a display device includes: the polyamideimide film according to any one of the embodiments; and a coating layer formed on the polyamideimide film.

In still another general aspect, a display device includes the polyamideimide film according to any one of the embodiments.

Other features and aspects will be apparent from the following detailed description, the drawings, and the claims.

### DESCRIPTION OF THE INVENTION

Hereinafter, some embodiments of the present disclosure will be described in detail so that those skilled in the art may easily practice the embodiments of the present disclosure. However, the embodiments may be implemented in various different forms, and the present disclosure is not limited to the embodiments described herein. In addition, the following description is not intended to limit the scope of protection defined by the claims.

In addition, unless defined otherwise, the technical and scientific terms described in the present specification have the same meanings as commonly understood by those skilled in the art.

Throughout the present specification, unless explicitly described to the contrary, “comprising” any component may be understood to imply further inclusion of other components rather than the exclusion of any other components.

Hereinafter, unless otherwise specifically defined in the present specification, a “combination thereof” refers to mixing or copolymerization of constituents.

Hereinafter, unless otherwise specifically defined in the present specification, “A and/or B” may refer to an aspect including both A and B, and may refer to an aspect selected from A and B.

Hereinafter, unless otherwise specifically defined in the present specification, a “polymer” may include an oligomer and a polymer, and may include a homopolymer and a copolymer. The copolymer may include an alternating copolymer, a block copolymer, a random copolymer, a branched copolymer, a crosslinked copolymer, or all of the copolymers.

Hereinafter, unless otherwise specifically defined in the present specification, “polyamic acid” may refer to a polymer including a structural unit having an amic acid moiety, and “polyamideimide” may refer to a polymer including a structural unit having an amide moiety and an imide moiety.

Hereinafter, unless otherwise specifically defined in the present specification, a polyamideimide film may be a film containing polyamideimide, and specifically, a high heat-resistant film produced by subjecting a dianhydride compound and a diacid dichloride to solution polymerization in a diamine compound solution to prepare polyamic acid, and then imidizing the polyamic acid by ring-closing dehydration at a high temperature.

Hereinafter, unless otherwise specifically defined in the present specification, it will be understood that when an element such as a layer, a film, a thin film, a region, or a plate, is referred to as being “above” or “on” another element, it may be “directly on” another element or may have an intervening element present therebetween.

Hereinafter, unless otherwise specifically defined in the present specification, “(meth)acryl” may be used to include “methacryl” and “acryl”.

Hereinafter, unless otherwise specifically defined in the present specification, a “polyfunctional (meth)acrylic crosslinked polymer” may refer to a crosslinked polymer formed by crosslinking polyfunctional (meth)acrylic compounds having (meth)acrylic groups. The polyfunctional (meth)acrylic crosslinked polymer may or may not have a (meth)acrylic group, for example, a (meth)acrylate group.

Hereinafter, a polyamideimide film-forming composition according to one embodiment will be described.

In order to apply a polyimide film to a display device, it may be very important to improve an intrinsic yellow index of the polyimide film and impart colorless and transparent performance. To this end, studies to reduce a charge transfer complex (CTC) effect by combining monomers having various structures so as to prepare colorless and transparent polyimide have been continuously conducted. However, in the case of the transparent polyimide film produced by the above method, there is a limit in that a residual yellow color is still exhibited and a yellow index is increased as a thickness of the film is increased.

A composition for forming a polyamideimide film (hereinafter, referred to as a polyamideimide film-forming composition) according to one embodiment contains: polyamic acid or polyamideimide including a diamine-derived structural unit, a dianhydride-derived structural unit, and a diacid dichloride-derived structural unit; and an additive, such that colorless and transparent optical properties may be implemented in a thickness range in which the polyamideimide film has mechanical strength similar to that of tempered glass.

In this case, the diamine-derived structural unit may include a structural unit derived from a compound represented by the following Chemical Formula 1, the dianhydride-derived structural unit may include a structural unit derived from a compound represented by the following Chemical Formula 2, and the diacid dichloride-derived structural unit may include a structural unit derived from one or more of a compound represented by the following Chemical Formula 3 and a compound represented by the following Chemical Formula 4.

In addition, the additive may contain inorganic nanoparticles, a polyfunctional (meth)acrylic compound, and one or more of blue-based pigments and dyes.

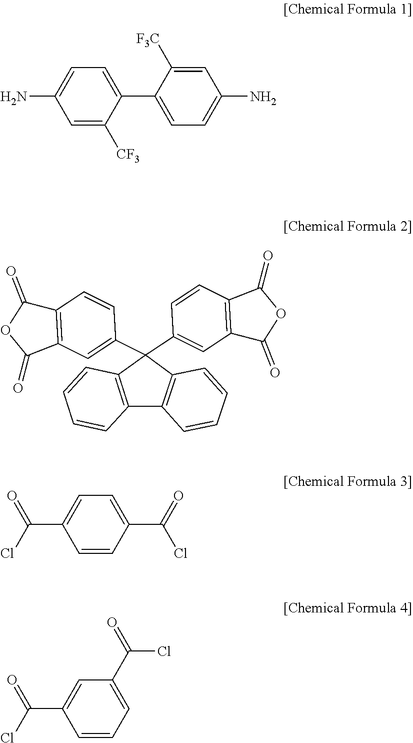 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

The inorganic nanoparticles may be contained in an amount of 5 wt % to 40 wt % with respect to a solid content in the polyamic acid and/or the polyamideimide. Wt % of the inorganic nanoparticles is not limited within the above range, and the inorganic nanoparticles may be contained in an amount of, for example, 5 wt % to 40 wt %, 10 wt % to 40 wt %, 15 wt % to 40 wt %, 20 wt % to 40 wt %, or 25 wt % to 40 wt %, with respect to the solid content in the polyamic acid and/or the polyamideimide. The inorganic nanoparticles are added in the above content, such that it is possible to provide a polyamideimide film that is more transparent and has a low thickness direction retardation and excellent mechanical properties. In this case, the solid in the polyamic acid and/or the polyamideimide may refer to polyamic acid and/or polyamideimide.

The inorganic nanoparticles may comprise, for example, silica, zirconium oxide, titanium oxide, zinc oxide, zinc sulfide, chromium oxide, barium titanate, or a combination thereof.

An average diameter of the inorganic nanoparticles is not limited to a specific range, and may be, for example, 5 nm to 50 nm, 5 nm to 30 nm, or 5 nm to 20 nm.

The inorganic nanoparticles may be mixed with a polyamideimide resin in a dispersed form in an organic solvent, and may be materials whose surfaces are treated to improve dispersibility.

The polyfunctional (meth)acrylic compound may be contained in an amount of 2 wt % to 10 wt % with respect to the solid content in the polyamic acid and/or the polyamideimide. Wt % of the polyfunctional (meth)acrylic compound is not limited within the above range, and the polyfunctional (meth)acrylic compound may be contained in an amount of, for example, 2 wt % to 10 wt %, 3 wt % to 10 wt %, 4 wt % to 10 wt %, or 5 wt % to 10 wt %, with respect to the solid content in the polyamic acid and/or the polyamideimide. The polyfunctional (meth)acrylic compound is added in the above content, such that it is possible to provide a polyamideimide film that is more transparent and has a low thickness direction retardation and excellent mechanical properties. In this case, the solid in the polyamic acid and/or the polyamideimide may refer to polyamic acid and/or polyamideimide.

The polyfunctional (meth)acrylic compound is a compound having a polyfunctional (meth)acrylic group, and the (meth)acrylic group may be, for example, a (meth)acrylate group. The polyfunctional (meth)acrylic compound may include, for example, trimethylolpropane tri(meth)acrylate, trimethylolethane tri(meth)acrylate, 1,2,4,5-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa(meth)acrylate, polyfunctional urethane (meth)acrylate, polyfunctional polyester (meth)acrylate, or a combination thereof.

Alternatively, the polyfunctional (meth)acrylic compound may further include an alkylene group, an ether group, a urethane group, an ester group, or a combination thereof.

The polyfunctional (meth)acrylic compound according to one embodiment may form a polyfunctional (meth)acrylic crosslinked polymer by means such as subsequent heating, and the crosslinked polymer may be a polymer in which all or some polyfunctional (meth)acrylic compounds are crosslinked, but is not limited thereto. In addition, the polyfunctional (meth)acrylic crosslinked polymer may be dispersed in the polyamideimide film-forming composition to form a composite. However, a bond between the polyfunctional (meth)acrylic crosslinked polymer and the polyamideimide polymer may not include a chemical bond, and for example, the polyfunctional (meth)acrylic crosslinked polymer and the polyamideimide polymer may not be covalently bonded to each other.

A maximum absorption wavelength of the blue-based pigment or dye is not particularly limited as long as it includes a yellow-based wavelength range, and may be, for example, 520 nm to 650 nm, 550 nm to 650 nm, or 550 nm to 620 nm. The pigment or dye having a maximum absorption wavelength in the above range is used, such that a light absorption phenomenon of a blue or violet wavelength of the polyamideimide film formed of the polyamic acid or the polyamideimide including the structural units described above may be effectively offset and a yellow index may be more effectively improved. Furthermore, a maximum absorption wavelength range of an inorganic pigment is appropriately selected depending on the kind and composition of the monomers used for preparing the polyamideimide film-forming composition, or optical properties of the polyamideimide film, such that optical properties of the film such as a yellow index, a refractive index, and a thickness direction retardation may be more excellent.

As the pigment, a blue-based pigment or a known pigment having a maximum absorption wavelength of 520 nm to 650 nm may be used without particular limitation, and the pigment may be an inorganic pigment containing, for example, natural minerals; or one or more metals selected from zinc, titanium, lead, iron, copper, chromium, cobalt, molybdenum, manganese, and aluminum, or metal oxides thereof. The pigment may be contained in a pigment dispersion together with a dispersing agent.

An average particle size of the inorganic pigments may be 30 nm to 100 nm. Alternatively, the average particle size of the inorganic pigments is not limited, and may be, 50 nm to 100 nm or 70 nm to 100 nm. The average particle size of the inorganic pigments may be measured, for example, in a dispersion or in a polyamideimide film. In addition, a solid phase average particle size of the pigments before dispersion may be, for example, 10 nm to 70 nm, 30 nm to 70 nm, or 50 nm to 70 nm.

In order to improve dispersibility of the pigments, means such as ultrasonic waves may be used, and a dispersing agent may be used. The dispersing agent is not particularly limited as long as it may prevent aggregation between the pigments and improve dispersibility and dispersion stability of the pigments. For example, the dispersing agent may have a functional group adsorbed to the pigment and a functional group having high affinity to a dispersion medium (the organic solvent), and a dispersing agent may be determined by adjusting a balance of the two functional groups. Various kinds of dispersing agents may be used according to a surface state of the pigment to be dispersed. For example, the dispersing agent for the pigments according to one embodiment may have an acidic functional group, and in the case, the acidic functional group may be adsorbed to the pigment. The acidic functional group may be, for example, a carboxylic acid.

As the dye, a blue-based dye or a known dye having a maximum absorption wavelength of 520 nm to 650 nm may be used without particular limitation, and examples of the dye include an acid dye, a direct dye, and a mordant dye. Alternatively, examples of the dye include compounds classified as having a color other than pigments in the color index (published by The Society of Dyers and Colourists) and known dyes described in the dyeing note (dyed yarns). Alternatively, examples of the dye include an azo-based dye, a cyanine-based dye, a triphenylmethane-based dye, a phthalocyanine-based dye, an anthraquinone-based dye, a naphthoquinone-based dye, a quinone imine-based dye, a methine-based dye, an azomethine-based dye, a squarylium-based dye, an acridine-based dye, a styryl-based dye, a coumarin-based dye, a quinoline-based dye, a nitro-based dye, and an indigo-based dye in terms of chemical structure.

The pigments according to one embodiment may be contained in an amount of 10 ppm to 1,500 ppm, 100 ppm to 1,500 ppm, or 500 ppm to 1,500 ppm, with respect to the solid content in the polyamic acid and/or the polyamideimide. In this case, the solid in the polyamic acid and/or the polyamideimide may refer to polyamic acid and/or polyamideimide.

The dyes according to one embodiment may be contained in an amount of 10 ppm to 500 ppm, 10 ppm to 300 ppm, 10 ppm to 200 ppm, 50 ppm to 200 ppm, or 80 ppm to 200 ppm, with respect to the solid content in the polyamic acid and/or the polyamideimide. In this case, the solid in the polyamic acid and/or the polyamideimide may refer to polyamic acid and/or polyamideimide.

In one embodiment, the additive may further include a general additive added to the composition for forming a polyamideimide film or a polyimide film, and may further include, for example, a flame retardant, an adhesion enhancer, an antioxidant, a UV inhibitor, or a plasticizer.

In addition, the polyamideimide film-forming composition according to one embodiment may satisfy the following Expression 1. While not wishing to be bound by a certain theory, the polyamideimide film-forming composition satisfying such a condition may be advantageously applied to a thin film process when forming a film, may inhibit a packing density of a polyamideimide film during curing, and may render the polyamideimide film amorphous, resulting in improvement of the optical properties.

5,000≤V_{PAI}≤40,000 [Expression 1]

wherein

V_{PAI} is a viscosity of the polyamideimide film-forming composition when a solid content in the polyamic acid or the polyamideimide is 14 wt % with respect to the total weight of the polyamideimide film-forming composition, and the viscosity is a viscosity (unit: cp) measured at 25° C. with a Brookfield rotational viscometer using a 52Z spindle based on a torque of 80% and a time of 2 minutes. The viscosity (V_{PAI}) may be, for example, 5,000 cp to 30,000 cp, 5,000 cp to 25,000 cp, 5,000 cp to 20,000 cp, or 5,000 cp to 15,000 cp. Therefore, the polyamideimide film-forming composition containing a high solid content may be more easily applied to a thin film process, and may provide a polyamideimide film having further excellent colorless and transparent performance, optical properties, and heat resistance. In this case, the solid may be the polyamic acid and/or the polyamideimide.

The polyamideimide film includes the structural units derived from the compounds represented by Chemical Formulas 1 and 2, and one or more of the compound represented by Chemical Formula 3 and the compound represented by Chemical Formula 4, such that a distortion due to light may be further prevented in comparison to a polyamideimide film containing a polyamideimide polymer having a rigid structure. For example, in the polyamideimide film according to one embodiment, the dianhydride-derived structural unit may not include a rigid structural unit. For example, the dianhydride-derived structural unit may not include a structural unit derived from a dianhydride in which two anhydride groups are fused to one ring. The ring may be a single ring or a fused ring, and may be an aromatic ring, an aliphatic ring, or a combination thereof. Specifically, the dianhydride-derived structural unit may not include a structural unit derived from pyromellitic dianhydride (PMDA), a structural unit derived from cyclobutane-1,2,3,4-tetracarboxylic dianhydride (CBDA), or a combination thereof.

In one embodiment, the diacid dichloride-derived structural unit may be included in an amount of 5 mol % to 50 mol % with respect to 100 mol % of the diamine-derived structural unit. Alternatively, the diacid dichloride-derived structural unit may be included in an amount of 10 mol % to 50 mol %, 10 mol % to 40 mol %, 5 mol % to 40 mol %, or 20 mol % to 40 mol %, with respect to the content of 100 mol % of the diamine-derived structural unit. In this case, specifically, the diacid dichloride-derived structural unit may be a structural unit derived from one or more of a compound represented by Chemical Formula 3 and a compound represented by Chemical Formula 4, and the diamine-derived structural unit may be a structural unit derived from a compound represented by Chemical Formula 1. The polyamideimide film according to one embodiment includes the diacid dichloride-derived structural unit in an amount within the above range with respect to 100 mol % of the diamine-derived structural unit, such that the polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

In one embodiment, when the diacid dichloride-derived structural unit includes both structural units derived from the compound represented by Chemical Formula 3 and the compound represented by Chemical Formula 4, the structural unit derived from the compound represented by Chemical Formula 3 may be included in an amount of more than 50 mol % and less than 90 mol % with respect to a total of 100 mol % of the structural unit derived from the compound represented by Chemical Formula 3 and the structural unit derived from the compound represented by Chemical Formula 4. Alternatively, the structural unit derived from the compound represented by Chemical Formula 3 may be included in an amount of more than 55 mol % and less than 90 mol %, more than 60 mol % and less than 90 mol %, more than 50 mol % and 88 mol % or less, or more than 50 mol % and 85 mol % or less, with respect to the total of 100 mol % of the structural unit derived from the compound represented by Chemical Formula 3 and the structural unit derived from the compound represented by Chemical Formula 4. A molar ratio of the structural unit derived from the compound represented by Chemical Formula 3 and the structural unit derived from the compound represented by Chemical Formula 4 may be 1.1:1 to 9:1, 1.1:1 to 8:1, 1.1:1 to 7:1, 1.1:1 to 6:1, 1.5:1 to 8:1, 1.5:1 to 7:1, or 1.5:1 to 6:1. However, the molar ratio is not limited to the above range.

A molar ratio of the dianhydride-derived structural unit and the diacid dichloride-derived structural unit included in the polyamideimide film-forming composition according to one embodiment may be 5:95 to 95:5, 5:95 to 80:20, 10:90 to 60:40, 5:95 to 50:50, 5:95 to 40:60, 10:90 to 40:60, 5:95 to 35:65, 90:10 to 50:50, 90:10 to 60:40, 95:5 to 60:40, or 80:20 to 60:40. Specifically, when the diacid dichloride-derived structural unit includes a structural unit derived from any one of a compound represented by Chemical Formula 3 and a compound represented by Chemical Formula 4, a molar ratio of the dianhydride-derived structural unit and the diacid dichloride-derived structural unit may be 95:5 to 50:50, 90:10 to 50:50, 90:10 to 60:40, 95:5 to 60:40, or 80:20 to 60:40, and when the dianhydride-derived structural unit includes both structural units derived from a compound represented by Chemical Formula 3 and a compound represented by Chemical Formula 4, a molar ratio of the dianhydride-derived structural unit and the diacid dichloride-derived structural unit may be 5:95 to 95:5, 5:95 to 80:20, 10:90 to 60:40, 5:95 to 50:50, 5:95 to 40:60, 10:90 to 40:60, or 5:95 to 35:65. However, the molar ratio is not limited to the above range. The polyamideimide film according to one embodiment includes the dianhydride-derived structural unit and the diacid dichloride-derived structural unit at the above molar ratio, such that the polyamideimide film may be more transparent and have a low thickness direction retardation and excellent mechanical properties such as a high modulus and elongation at break. Therefore, the polyamideimide film may implement optical properties and mechanical properties equivalent to or superior to those of tempered glass.

In addition, as the diamine, one or a mixture of two or more selected from p-phenylenediamine (p-PDA), m-phenylenediamine (m-PDA), 4,4′-oxydianiline (4,4′-ODA), 3,4′-oxydianiline (3,4′-ODA), 2,2-bis[4-(4-aminophenoxy)phenyl]propane (BAPP), 1,4-bis(4-aminophenoxy)benzene (TPE-Q), 1,3-bis(4-aminophenoxy)benzene (TPE-R), 4,4′-bis(4-aminophenoxy)biphenyl (BAPB), 2,2-bis[4-(4-aminophenoxy)phenyl]sulfone (BAPS), 2,2-bis[4-(3-aminophenoxy)phenyl]sulfone (m-BAPS), 3,3′-dihydroxy-4,4′-diaminobiphenyl (HAB), 3,3′-dimethylbenzidine (TB), 2,2′-dimethylbenzidine (m-TB), 2,2′-bis(trifluoromethyl)benzidine (TFMB), 1,4-bis(4-amino-2-trifluoromethylphenoxy)benzene (6FAPB), 2,2′-bis(trifluoromethyl)-4,4′-diaminodiphenyl ether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, and 5-amino-2-(4-aminophenyl)benzoxazole may be used, if necessary, but is not limited thereto.

In addition, the dianhydride may further include pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2′-bis-(3,4-dicarboxyphenyl)hexafluoropropane dianhydride (6FDA), p-phenylene bistrimellitic monoester anhydride (TMHQ), 2,2-bis(4-hydroxyphenyl)propanedibenzoate-3,3′,4,4′-tetracarboxylic dianhydride (ESDA), naphthalenetetracarboxylic dianhydride (NTDA), or a combination thereof, if necessary.

In addition, the diacid dichloride may further include [1,1′-biphenyl]-4,4′-dicarbonyl dichloride (BPC), 1,4-naphthalenedicarboxylic acid dichloride (NPC), 2,6-naphthalenedicarboxylic acid dichloride (NTC), 1,5-naphthalenedicarboxylic acid dichloride (NEC), or a combination thereof, if necessary.

The polyamideimide film according to one embodiment may be produced using a polyamideimide resin including the diamine-derived structural unit, the dianhydride-derived structural unit, and the diacid dichloride-derived structural unit described above. In this case, the polyamideimide resin may have a weight average molecular weight (Mw) of 10,000 g/mol to 80,000 g/mol, 10,000 g/mol to 7,000 g/mol, or 10,000 g/mol to 6,000 g/mol, but is not limited thereto.

A solid content in the polyamideimide film-forming composition according to one embodiment may be 40 wt % or less, 10 wt % to 40 wt %, 35 wt % or less, 30 wt % or less, or 10 wt % to 25 wt %, with respect to the total weight of the polyamideimide film-forming composition. In this case, the solid may be the polyamic acid or the polyamideimide.

Hereinafter, a method of preparing a polyamideimide film-forming composition according to one embodiment will be described.

A method of preparing a polyamideimide film-forming composition according to one embodiment may include:

preparing a reaction product of a diamine and a diacid dichloride;

preparing a polyamic acid solution by adding the reaction product of the diamine and the diacid dichloride and a dianhydride to a reaction medium containing one or more of blue-based pigments and dyes and allowing a reaction to proceed; and

adding, to the polyamic acid solution, inorganic nanoparticles in an amount of 5 wt % to 40 wt % with respect to a solid content in polyamic acid or polyamideimide and a polyfunctional (meth)acrylic compound in an amount of 2 wt % to 10 wt % with respect to the solid content in the polyamic acid or the polyamideimide,

wherein the diamine contains a compound represented by the following Chemical Formula 1, the dianhydride contains a compound represented by the following Chemical Formula 2, and the diacid dichloride contains any one of a compound represented by the following Chemical Formula 3 and a compound represented by the following Chemical Formula 4:

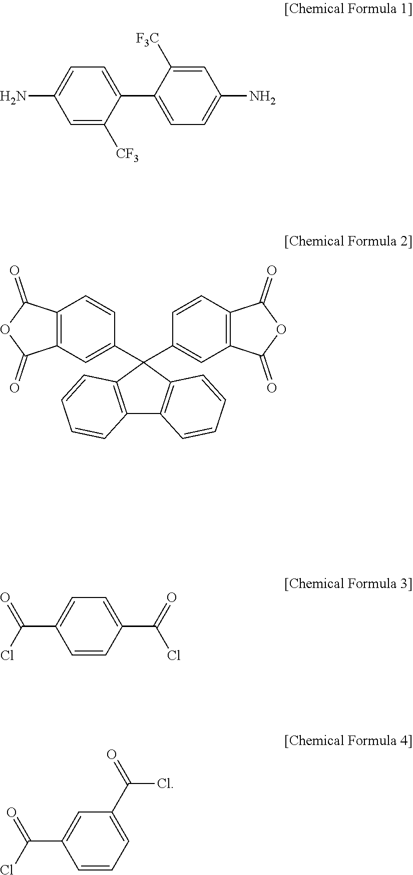 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

The method of preparing a polyamideimide film-forming composition according to one embodiment may further include preparing a diamine solution by mixing the diamine and a solvent, and then adding a diacid dichloride to the diamine solution and allowing a reaction to proceed.

The method of preparing a polyamideimide film-forming composition according to one embodiment may further include, after the preparing of the polyamic acid solution, adjusting a viscosity by adding an organic solvent to satisfy the following Expression 1:

5,000≤V_{PAI}≤40,000 [Expression 1]

wherein

V_{PAI} is a viscosity of the polyamideimide film-forming composition when a solid content in the polyamic acid or the polyamideimide is 14 wt % with respect to the total weight of the polyamideimide film-forming composition, and the viscosity is a viscosity (unit: cp) measured at 25° C. with a Brookfield rotational viscometer using a 52Z spindle based on a torque of 80% and a time of 2 minutes.

In the method of preparing a polyamideimide film-forming composition, the preparing of the polyamic acid solution may be performed in an organic solvent, a polar solvent, specifically, in an amide-based solvent. The amide-based solvent may refer to a compound having an amide moiety. The amide-based solvent may be an aromatic or aliphatic solvent, and may be, for example, an aliphatic solvent. In addition, the amide-based solvent may be, for example, a cyclic compound or a chain compound. Specifically, the amide-based solvent may have 2 to 15 carbon atoms, and may have, for example, 3 to 10 carbon atoms. The amide-based solvent may have an N,N-dialkylamide moiety. Dialkyl groups may be each independently present or may be fused with each other to form a ring, or at least one alkyl group in the dialkyl group may be fused with another substituent in the molecule to form a ring. For example, at least one alkyl group in the dialkyl group may be fused with an alkyl group linked to a carbonyl carbon of the amide moiety to form a ring. In this case, the ring may be a 4- to 7-membered ring, and may be, for example, a 5- to 7-membered ring or a 5- or 6-membered ring. The alkyl group may be, for example, a C₁₋₁₀ alkyl group or a alkyl group, and may be, for example, methyl, ethyl, or the like. More specifically, the amide-based solvent is not limited as long as it is generally used in polymerization of polyamic acid and/or polyamideimide, and examples thereof include dimethylpropionamide, diethylpropionamide, dimethylacetylamide, diethylacetamide, dimethylformamide, methylpyrrolidone, ethylpyrrolidone, octylpyrrolidone, and a combination thereof. Specifically, the amide-based solvent may contain dimethylpropionamide.

In the method of preparing a polyamideimide film-forming composition according to one embodiment, a blue-based pigment or dye may be added in polymerizing of polyamic acid and/or polyamideimide. Specifically, a diamine solution may be prepared by reacting a diamine and a solvent, a diamino oligomer may be prepared by adding a diacid dichloride to the prepared diamine solution and allowing a reaction to proceed, and the diamino oligomer may be added to and dissolved in a reaction medium containing a blue-based pigment or dye. Meanwhile, the dye may be added in advance, may be added at the start of a polymerization reaction, or may be added after polymerization, but there is no restriction on the order of addition. In addition, in a case where the pigment is added and dispersed after the polymerization of the polyamic acid and/or the polyamideimide is completed, the pigment may not be uniformly dispersed, and optical properties of the polyamideimide film may be deteriorated. An experiment is performed with the same composition as that of Example 1, but a pigment dispersion is added after polymerization of polyamic acid and/or polyamideimide, and as a result, it is confirmed that the pigment is not dispersed at all. On the other hand, in a case where a pigment or a dye is added together with polyamic acid and/or polyamideimide monomers in the polymerization of the polyamic acid and/or the polyamideimide, it is possible to secure stable dispersibility of the pigment or the dye. That is, the pigment or the dye is added together with the monomers in the polymerization of the polyamic acid and/or the polyamideimide, such that dispersibility of the pigment or the dye in the polyamideimide film-forming composition may be significantly improved, and thus, a yellow index may be improved without deterioration of mechanical properties of the film even after curing.

In addition, in the method of preparing a polyamideimide film-forming composition according to one embodiment, the description described above may be applied to the polyamideimide film-forming composition.

Hereinafter, a polyamideimide film according to one embodiment will be described.

The polyamideimide film according to one embodiment may be obtained by curing the polyamideimide film-forming composition according to any one of the embodiments.

The polyamideimide film according to one embodiment may implement a low thickness direction retardation and may have further improved visibility while being transparent even at a thickness of 20 μm or more, such that a cover window including the polyamideimide film may further reduce eye fatigue of a user. In addition, the polyamideimide film may have further improved mechanical strength as well as excellent optical properties even at a thickness of 20 μm or more as described above, and thus may have further improved dynamic bending properties. Therefore, the polyamideimide film may be suitable for a use as a cover window of a foldable display device or a flexible display device that repeatedly folds and unfolds.

An elongation at break of the polyamideimide film according to one embodiment may be 10% or more. Alternatively, the elongation at break of the polyamideimide film according to one embodiment may be 10% to 20%, 10% to 18%, 11% or more, 11% to 20%, or 10% to 16%, but is not limited within the above range.

An absolute value of a thickness direction retardation of the polyamideimide film according to one embodiment may be 950 nm or less when measured at a wavelength of 550 nm. Alternatively, the thickness direction retardation may be, for example, 900 nm or less, 800 nm or less, 200 nm to 950 nm, 300 nm to 900 nm, 400 nm to 950 nm, 500 nm to 950 nm, 600 nm to 950 nm, 500 nm to 900 nm, 600 nm less, 200 nm to 600 nm, 200 nm to 500 nm, 250 nm to 600 nm, 250 nm to 550 nm, 300 nm to 600 nm, or 300 nm to 500 nm, but is not limited to the above range. The thickness direction retardation value may be measured at a normal temperature before heating the film, and the normal temperature may be a temperature in a state in which the temperature is not artificially controlled. For example, the normal temperature may be 20° C. to 40° C., 20° C. to 30° C., or 23° C. to 26° C. The polyamideimide film according to one embodiment satisfies both the elongation at break and the thickness direction retardation, such that it is possible to provide sufficient mechanical properties and durability to be applied to a cover window for a display device.

A yellow index (YI) of the polyamideimide film according to one embodiment may be 3.5 or less when measured according to ASTM E313. Alternatively, the yellow index may be, for example, 3.0 or less, 1.0 to 3.5, 1.5 to 3.5, 1.0 to 3.0, 1.5 to 3.0, 1.0 to 2.8, 1.5 to 2.8, or 2.0 to 3.0, but is not limited to the above range.

A modulus of the polyamideimide film according to one embodiment may be 3.5 GPa or more, 4.0 GPa or more, 4.3 GPa or more, 4.0 GPa to 6.0 GPa, 5.0 GPa or more, 5.0 GPa to 7.0 GPa, 5.3 GPa or more, 5.5 GPa or more, 5.3 GPa to 6.5 GPa, or 5.5 GPa to 6.5 GPa, when measured according to ASTM E111.

A thickness of the polyamideimide film according to one embodiment may be 20 μm to 500 μm. Alternatively, the thickness may be, for example, 20 μm to 300 μm, 20 μm to 250 μm, 20 μm to 200 μm, 20 μm to 150 μm, 20 μm to 100 μm, 30 μm to 100 μm, or 20 μm to 80 μm.

The polyamideimide film according to one embodiment satisfies the physical properties within the above ranges, and thus an image distortion due to light may be prevented, such that it is possible to impart further improved visibility. In addition, the polyamideimide film may exhibit more uniform mechanical properties (an elongation at break the like) and optical properties (a thickness direction retardation and the like) in the entire central portion and edge portion thereof, and may further reduce a film loss. In addition, since the polyamideimide film is flexible and has excellent bending properties, and the polyamideimide film may prevent a deformation and/or damage to the film even when a predetermined deformation occurs repeatedly, and may be more easily restored to the original shape. In addition, a cover window including the polyamideimide film according to one embodiment may have more excellent visibility and may prevent folded marks and micro-cracks, and thus may impart more excellent durability and long-term life to a foldable display device or a flexible display device.

Hereinafter, a method of producing a polyamideimide film according to one embodiment will be described.

The method of producing a polyamideimide film according to one embodiment may include applying the polyamideimide film-forming composition according to one embodiment to a substrate and then performing a heat treatment.

In the method of producing a polyamideimide film according to one embodiment, the heat treatment in the performing of the heat treatment is not necessarily performed in a specific temperature range, but may be performed at 280° C. or higher and 350° C. or lower for 10 minutes to 60 minutes. In a case where the curing is performed at a relatively low temperature, the film has a reduced thermal history, and thus, the yellow index tends to be relatively lowered, but in a case where the curing is performed at a temperature lower than a glass transition temperature (Tg), the thickness direction retardation may be increased due to an orientation of a molecular structure. In addition, the thermal curing may be performed, for example, in a separate vacuum oven or an oven filled with an inert gas.

In addition, before the performing of the heat treatment, a drying step may be additionally performed, if necessary. The drying step is also not necessarily performed in a specific temperature range, but may be performed at, for example, 50° C. to 150° C., 50° C. to 130° C., 60° C. to 100° C., or about 80° C.

The method of producing a polyamideimide film according to one embodiment may further include, after the applying of the polyamideimide film-forming composition to the substrate, allowing the polyamideimide film-forming composition to stand at a normal temperature, if necessary. Optical properties of a surface of the film may be further stably maintained by the allowing of the polyamideimide film-forming composition to stand. While not wishing to be bound by a certain theory, when a polyamideimide film-forming composition according to the related art is allowed to stand before being cured, a solvent absorbs moisture in the air, the moisture diffuses inside the solvent, and the moisture collides with polyamic acid and/or polyamideimide, which causes whitening from a surface of a film and cissing, and as a result, coating unevenness may occur. On the other hand, the polyamideimide film-forming composition according to one embodiment does not cause whitening and cissing even when allowed to stand in the air for a long time, and may realize the advantage of being able to secure a film having improved optical properties. The allowing of the polyamideimide film-forming composition to stand may be performed under normal temperature and/or high humidity conditions. In this case, the normal temperature may be 40° C. or lower, 30° C. or lower, or 25° C. or lower, more specifically may be 15° C. to 25° C., and particularly preferably, may be 20° C. to 25° C. In addition, the high humidity may be a relative humidity of 50% or more, 60% or more, 70% or more, or 80% or more. The allowing of the polyamideimide film-forming composition to stand may be performed for 1 minute to 3 hours, 10 minutes to 2 hours, or 20 minutes to 1 hour.

In addition, in the method of producing a polyamideimide film according to one embodiment, as a method for the application for forming the polyamideimide film, any method may be used without limitation as long as it is commonly used in the art. Non-limiting examples thereof include a knife coating method, a dip coating method, a roll coating method, a slot die coating method, a lip die coating method, a slide coating method, and a curtain coating method, and the same or different methods may be sequentially applied one or more times.

The substrate may be used without limitation as long as it is commonly used in the art, and as a non-limiting example thereof, glass; stainless steel; or a plastic film formed of polyethylene terephthalate, polyethylene naphthalate, polypropylene, polyethylene, cellulose triacetate, cellulose diacetate, poly(meth)acrylic acid alkyl ester, a poly(meth)acrylic acid ester copolymer, polyvinyl chloride, polyvinyl alcohol, polycarbonate, polystyrene, cellophane, a polyvinylidene chloride copolymer, polyamide, polyamideimide, a vinyl chloride-vinyl acetate copolymer, polytetrafluoroethylene, or polytrifluoroethylene may be used.

Hereinafter, a use of the polyamideimide film according to one embodiment will be described.

An aspect according to one embodiment may be a multi-layered structure including the polyamideimide film according to one embodiment. For example, the multi-layered structure may be a cover window for a display device including: the polyamideimide film; and a coating layer disposed on the polyamideimide film. In addition, the multi-layered structure may include a polyamideimide film containing monomers having compositions different from those of the polyamideimide film according to one embodiment, and two or more coating layers.

In this case, non-limiting examples of the coating layer includes a hard coating layer, an antistatic layer, an anti-fingerprint layer, an anti-fouling layer, an anti-scratch layer, a low-refractive layer, an anti-reflective layer, an impact absorption layer, and a combination thereof, but are not limited thereto. In this case, a thickness of the coating layer may be 1 μm to 500 μm, 2 μm to 450 μm, or 2 μm to 200 μm, but is not limited thereto.

In addition, the multi-layered structure according to one embodiment may include the polyamideimide film according to one embodiment and a semiconductor layer that are formed on a substrate. Non-limiting examples of a material of the semiconductor layer include low-temperature polysilicon (LIPS), low-temperature polyoxide (LTPO), indium tin oxide (ITO), and indium gallium zinc oxide (IGZO), and the semiconductor layer may contain, for example, LIPS and/or LTPO. In a case of a display device obtained using low-temperature polysilicon (LIPS) and/or low-temperature polycrystalline oxide (LTPO), a process temperature may be close to 350° C. or higher and 500° C. or lower. In such a high-temperature process, even polyamideimide having excellent heat resistance is easily thermally decomposed by hydrolysis. Therefore, in order to manufacture an LIPS and/or LTPO flexible device, there is a need for a material having excellent heat resistance in which thermal decomposition by hydrolysis does not occur even in a high-temperature process. The polyamideimide film according to one embodiment has excellent optical properties and heat resistance at the same time, and thus may be utilized in an LIPS and/or LTPO display device.

Another aspect according to one embodiment may be a display device including the polyamideimide film according to one embodiment.

As an example, the display device is not particularly limited as long as it belongs to a field requiring excellent optical properties, and may be provided by selecting a display panel appropriate therefor. Specifically, the display device may be applied to a flexible display device, and non-limiting examples thereof include, but are not limited to, various image display devices such as a liquid crystal display device, an electroluminescence display device, a plasma display device, and a field emission display device.

In addition, in the case of the display device including the polyamideimide film according to one embodiment, display quality may be excellent, in particular, a rainbow phenomenon in which iridescent stains occur may be significantly prevented because a distortion caused by light is significantly reduced, and it is possible to minimize the user's eye fatigue because visibility is excellent. In particular, in accordance with an increase in size of a screen of a display device, the screen has been often viewed from the side. In a case where the polyamideimide film for a cover window according to one embodiment is applied to the display device, the display device has excellent visibility even when viewed from the side. Therefore, the polyamideimide film may be usefully applied to a large display device.

Hereinafter, Examples and Experimental Examples according to one embodiment will be described in detail below. However, Examples and Experimental Examples described below are merely illustrative of one embodiment, but one embodiment is not limited thereto.

<Measurement Methods>

1. Yellow Index (YI)

A yellow index was measured in accordance with the ASTM E313 standard using a spectrophotometer (COH-5500, manufactured by Nippon Denshoku Industries Co., Ltd.).

2. Modulus and Elongation at Break

A modulus and an elongation at break were measured using a specimen having a thickness of 50 μm, a length of 50 mm, and a width of 10 mm according to ASTM E111 under a condition in which the specimen was pulled at 25° C. and 50 mm/min using UTM 3365 (manufactured by Instron Corporation). A unit of the modulus is GPa, and a unit of the elongation at break is %

3. Retardation (Rth)

A retardation was measured using Axoscan (OPMF, manufactured by Axometrics Inc.). A thickness direction retardation (Rth) was measured at a wavelength of 550 nm, and the thickness direction retardation (Rth) at a wavelength of 550 nm was indicated by an absolute value. A unit of the retardation is nm.

### Example 1

### Preparation of Polyamideimide Film-Forming Composition

A reactor was charged with 253 g of N,N-dimethylpropionamide (DMPA) in a nitrogen atmosphere. In a state where the temperature of the reactor was maintained at 25° C., 2,2′-bis(trifluoromethyl)-benzidine (TFMB) was added and stirred for 6 hours to be dissolved and react, and then terephthaloyl chloride (TPC) was added and stirred for 6 hours to be dissolved and react. Thereafter, the reaction product obtained by precipitation and filtration using an excessive amount of methanol was vacuum dried at 50° C. for 6 hours or longer to obtain a white powder.

The obtained white powder was added to and dissolved in the reactor in a nitrogen atmosphere again together with a solvent obtained by mixing DMPA with 1,200 ppm of a pigment dispersion in which an average particle size of the pigments in the dispersion was 90 nm (5 wt % in DMAc, OP-1803B, manufactured by Toyoink), 9,9-bis(3,4-dicarboxyphenyl)fluorene dianhydride (BPAF) was added, and the mixture was dissolved and reacted under stirring for 12 hours, thereby preparing a polyamic acid resin composition. At this time, a molar ratio of monomers of TFMB:BPAF:TPC was set to be as shown in Table 1, and a solid content was adjusted to 14 wt %. Next, silica particles (SSD 330 T, DMAc 30 wt %, 15 nm, manufactured by RANCO Co.,) and dipentaerythritol hexaacrylate (M500, manufactured by Miwon Commercial Co., Ltd.) were added in amounts of 25 wt % and 5 wt %, respectively, with respect to the polyamic acid or polyamideimide solid in the polyamic acid resin composition, and then the mixture was stirred for 5 hours, thereby preparing a polyamideimide film-forming composition.

Production of Polyamideimide Film

The obtained polyamideimide film-forming composition was applied to one surface of a glass substrate (1.0 T) with an applicator, heating was performed in a nitrogen atmosphere at 80° C. for 30 minutes and then at 300° C. for 15 minutes to cure the polyamideimide film-forming composition, and then the cured polyamideimide film-forming composition was peeled off from the glass substrate, thereby producing a polyamideimide film having a thickness of 50 μm.

### Example 2

A polyamideimide film-forming composition of Example 2 was prepared in the same manner as that of Example 1, except that wt % of DPHA as a polyfunctional acrylic compound was changed as shown in Table 2, and a polyamideimide film having a thickness of 50 μm of Example 2 was produced in the same manner as that of Example 1.

### Example 3

A polyamideimide film-forming composition of Example 3 was prepared by performing polymerization, adding 40 wt % of silica particles (330T, DMAc 30 wt %, 15 nm, manufactured by manufactured by RANCO Co.,), 5 wt % of DPHA (M500, manufactured by Miwon Commercial Co., Ltd.), and 120 ppm of a 5% diluted dye (SI1001, manufactured by Kyung-In Synthetic Corporation), and stirring the mixture for 5 hours, except for the adding of the pigment dispersion containing the pigment in Example 1. Next, a polyamideimide film of Example 3 was produced in the same manner as that of Example 1.

### Examples 4 and 5

Polyamideimide film-forming compositions of Examples 4 and 5 were prepared in the same manner as that of Example 1, except that isophthaloyl chloride (IPC) was used instead of TPC and wt % of each of the silica particles and DPHA was changed as shown in Table 2, and polyamideimide films each having a thickness of 50 μm of Examples 4 and 5 were produced in the same manner as that of Example 1.

### Example 6

A polyamideimide film-forming composition of Example 6 was prepared in the same manner as that of Example 3 except for using IPC instead of TPC, and a polyamideimide film having a thickness of 50 μm of Example 6 was produced in the same manner as that of Example 3.

### Example 7

### Preparation of Polyamideimide Film-Forming Composition

A reactor was charged with 253 g of N,N-dimethylpropionamide (DMPA) in a nitrogen atmosphere. In a state where the temperature of the reactor was maintained at 25° C., 2,2′-bis(trifluoromethyl)-benzidine (TFMB) was added and stirred for 6 hours to be dissolved and react, and then terephthaloyl chloride (TPC) was added and stirred for 6 hours to be dissolved and react. Thereafter, the reaction product obtained by precipitation and filtration using an excessive amount of methanol was vacuum dried at 50° C. for 6 hours or longer to obtain a white powder. Next, TFMB was reacted with isophthaloyl chloride (IPC) under the same conditions, and the mixture was stirred for 6 hours and then subjected to precipitation and drying in the same manner, thereby obtaining a white powder.

The obtained white powder was added to and dissolved in the reactor in a nitrogen atmosphere again together with a solvent obtained by mixing DMPA with 1,200 ppm of a pigment dispersion in which an average particle size of the pigments in the dispersion was 90 nm (5 wt % in DMAc, OP-1803B, manufactured by Toyoink), 9,9-bis(3,4-dicarboxyphenyl)fluorene dianhydride (BPAF) was added, and the mixture was dissolved and reacted under stirring for 12 hours, thereby preparing a polyamic acid resin composition. At this time, a molar ratio of monomers of TFMB:BPAF:TPC:IPC was set to be as shown in Table 1, and a solid content was adjusted to 14 wt %. Next, silica particles (SSD 330 T, DMAc 30 wt %, 15 nm, manufactured by RANCO Co.,) and dipentaerythritol hexaacrylate (M500, manufactured by Miwon Commercial Co., Ltd.) were added in amounts of 25 wt % and 5 wt %, respectively, with respect to the polyamic acid or polyamideimide solid in the polyamic acid resin composition, and then the mixture was stirred for 5 hours, thereby preparing a polyamideimide film-forming composition.

Production of Polyamideimide Film

The obtained polyamideimide film-forming composition was applied to one surface of a glass substrate (1.0 T) with an applicator, heating was performed in a nitrogen atmosphere at 80° C. for 30 minutes and then at 300° C. for 15 minutes to cure the polyamideimide film-forming composition, and then the cured polyamideimide film-forming composition was peeled off from the glass substrate, thereby producing a polyamideimide film having a thickness of 50 μm.

### Examples 8 and 9

Polyamideimide film-forming compositions of Examples 8 and 9 were prepared in the same manner as that of Example 7, except that the molar ratio of TFMB, BPAF, TPC, and IPC and wt % of the additives were changed as shown in Tables 1 and 2, and polyamideimide films each having a thickness of 50 μm of Examples 8 and 9 were produced in the same manner as that of Example 7.

### Example 10

A polyamideimide film-forming composition of Example 7 was prepared by performing polymerization, adding 40 wt % of silica particles (330T, DMAc 30 wt %, 15 nm, manufactured by manufactured by RANCO Co.,), 5 wt % of DPHA (M500, manufactured by Miwon Commercial Co., Ltd.), and 120 ppm of a 5% diluted dye (SI1001, manufactured by Kyung-In Synthetic Corporation), and stirring the mixture for 5 hours, except for the adding of the pigment dispersion containing the pigment in Example 10. Next, a polyamideimide film having a thickness of 50 μm of Example 10 was produced in the same manner as that of Example 7.

### Comparative Example 1

A polyamideimide film-forming composition of Comparative Example 1 was prepared in the same manner as that of Example 1 except that the inorganic nanoparticles, the polyfunctional acrylic compound, and the pigment were not added as additives, and a polyamideimide film having a thickness of 50 μm of Comparative Example 1 was produced in the same manner as that of Example 1.

### Comparative Examples 2 and 3

Polyamideimide film-forming compositions of Comparative Examples 2 and 3 were prepared in the same manner as that of Example 1, except that the molar ratio of TFMB, BPAF, and TPC and wt % of the additives were changed as shown in Tables 1 and 2, and polyamideimide films each having a thickness of 50 μm of Comparative Examples 2 and 3 were produced in the same manner as that of Example 1.

### Comparative Example 4

A polyamideimide film-forming composition of Comparative Example 4 was prepared in the same manner as that of Example 7 except that the inorganic nanoparticles, the polyfunctional acrylic compound, and the pigment were not added as additives, and a polyamideimide film having a thickness of 50 μm of Comparative Example 4 was produced in the same manner as that of Example 7.

### Comparative Example 5

A polyamideimide film-forming composition of Comparative Example 5 was prepared in the same manner as that of Example 7, except that the additives were changed as shown in Tables 2, and a polyamideimide film having a thickness of 50 μm of Comparative Example 5 was produced in the same manner as that of Example 7.

### Reference Examples 1 and 2

Polyamideimide film-forming compositions of Reference Examples 1 and 2 were prepared in the same manner as that of Example 7, except that the molar ratio of TFMB, BPAF, TPC, and IPC and wt % of the additives were changed as shown in Tables 1 and 2, and polyamideimide films each having a thickness of 50 μm of Reference Examples 1 and 2 were produced in the same manner as that of Example 7.

TABLE 1

| | TFMB | BPAF | TPC | IPC |
|---|---|---|---|---|
| Example 1 | 100 | 60 | 40 | — |
| Example 2 | 100 | 60 | 40 | — |
| Example 3 | 100 | 60 | 40 | — |
| Example 4 | 100 | 60 | — | 40 |
| Example 5 | 100 | 60 | — | 40 |
| Example 6 | 100 | 60 | — | 40 |
| Example 7 | 100 | 25 | 60 | 15 |
| Example 8 | 100 | 20 | 48 | 32 |
| Example 9 | 100 | 25 | 60 | 15 |
| Example 10 | 100 | 25 | 60 | 15 |
| Comparative | 100 | 60 | 40 | — |
| Example 1 | | | | |
| Comparative | 100 | 80 | 20 | — |
| Example 2 | | | | |
| Comparative | 100 | 40 | 60 | — |
| Example 3 | | | | |
| Comparative | 100 | 25 | 60 | 15 |
| Example 4 | | | | |
| Comparative | 100 | 25 | 60 | 15 |
| Example 5 | | | | |
| Reference | 100 | 28 | 65 | 7 |
| Example 1 | | | | |
| Reference | 100 | 20 | 40 | 40 |
| Example 2 | | | | |

TABLE 2

| | | Polyfunctional | | |
|---|---|---|---|---|
| | Inorganic | acrylic | | |
| | nanoparticles | compound | Dye | Pigment |
| | (wt %) | (wt %) | (ppm) | (ppm) |
| Example 1 | 25 | 5 | — | 1200 |
| Example 2 | 25 | 10 | — | 1200 |
| Example 3 | 40 | 5 | 120 | — |
| Example 4 | 25 | 5 | — | 1200 |
| Example 5 | 25 | 10 | — | 1200 |
| Example 6 | 40 | 5 | 120 | — |
| Example 7 | 25 | 5 | — | 1200 |
| Example 8 | 25 | 10 | — | 1200 |
| Example 9 | 40 | 5 | — | 1200 |
| Example 10 | 40 | 5 | 120 | — |
| Comparative | — | — | — | — |
| Example 1 | | | | |
| Comparative | 45 | 15 | — | 1200 |
| Example 2 | | | | |
| Comparative | 45 | 15 | — | 1200 |
| Example 3 | | | | |
| Comparative | — | — | — | — |
| Example 4 | | | | |
| Comparative | 45 | 15 | — | 1200 |
| Example 5 | | | | |
| Reference | 40 | 10 | — | 1200 |
| Example 1 | | | | |
| Reference | 40 | 10 | — | 1200 |
| Example 2 | | | | |

### <Experimental Example> Evaluation of Optical Properties and Mechanical Properties

The yellow index (YI), the elongation at break, the thickness direction retardation (Rth), and the modulus of the polyamideimide films according to Examples 1 to 10, Comparative Examples 1 to 5, and Reference Examples 1 and 2 were measured according to the measurement methods described above. The results thereof are shown in Tables 3 and 4.

TABLE 3

| | Example No. | | | | | |
|---|---|---|---|---|---|---|
| | 1 | 2 | 3 | 4 | 5 | 6 |
| Thickness | 50 | 50 | 50 | 50 | 50 | 50 |
| (μm) | | | | | | |
| Yellow | 2.7 | 2.4 | 2.7 | 2.4 | 2.2 | 2.3 |
| index | | | | | | |
| (YI) | | | | | | |
| Elongation | 15 | 11 | 11 | 15 | 11 | 10 |
| at break | | | | | | |
| (%) | | | | | | |
| Rth | 450 | 400 | 390 | 310 | 280 | 260 |
| (550 nm) | | | | | | |
| Modulus | 5.1 | 5.0 | 5.4 | 4.6 | 4.5 | 5.0 |
| (GPa) | | | | | | |
| | Comparative Example No. | | | | | |
| | 1 | 2 | 3 | | | |
| Thickness | 50 | 50 | 50 | | | |
| (μm) | | | | | | |
| Yellow | 3.4 | 4.0 | 3.9 | | | |
| index | | | | | | |
| (YI) | | | | | | |
| Elongation | 15 | 2 | 3 | | | |
| at break | | | | | | |
| (%) | | | | | | |
| Rth | 490 | 350 | 338 | | | |
| (550 nm) | | | | | | |
| Modulus | 4.7 | 5.1 | 4.7 | | | |
| (GPa) | | | | | | |

TABLE 4

Example No.

| | 7 | 8 | 9 | 10 |
|---|---|---|---|---|
| Thickness | 50 | 50 | 50 | 50 |
| (μm) | | | | |
| Yellow index | 3.2 | 3.0 | 3.0 | 2.9 |
| (YI) | | | | |
| Elongation | 14 | 13 | 11 | 11 |
| at break (%) | | | | |
| Rth | 890 | 850 | 790 | 805 |
| (550 nm) | | | | |
| Modulus | 5.6 | 5.5 | 5.9 | 5.7 |
| (GPa) | | | | |

| | Comparative Example No. | | Reference Example No. | |
|---|---|---|---|---|
| | 4 | 5 | 1 | 2 |
| Thickness | 50 | 50 | 50 | 50 |
| (μm) | | | | |
| Yellow index | 3.5 | 3.3 | 3.7 | 3.1 |
| (YI) | | | | |
| Elongation | 15 | 6 | 9 | 10 |
| at break (%) | | | | |
| Rth | 960 | 803 | 1080 | 780 |
| (550 nm) | | | | |
| Modulus | 5.3 | 5.7 | 5.5 | 4.4 |
| (GPa) | | | | |

As can be seen from Tables 3 and 4, the blue-based pigments or dyes, the inorganic nanoparticles, and the acrylic compound were further contained in the polyamideimide films produced using the polyamideimide film-forming compositions containing a diamine containing TFMB, an dianhydride containing BPAF, and a diacid dichloride containing one or more of TPC and IPC, such that an elongation at break, a modulus, and a retardation were excellent and a yellow index was further excellent in comparison to the polyamideimide film according to each of Comparative Examples. Therefore, it is possible to provide a film having significantly improved display quality and visibility.

As set forth above, the polyamideimide film-forming composition according to one embodiment and the polyamideimide film produced using the same may implement colorless and transparent optical properties even in a thickness range in which the polyamideimide film has mechanical strength similar to that of tempered glass. Further, since the polyamideimide film-forming composition according to one embodiment and the polyamideimide film produced using the same have excellent optical properties, the polyamideimide film may have excellent flexibility and mechanical properties as well as significantly improved display quality and visibility, and thus may be effectively applied for optical applications such as a foldable display device or a flexible display device.

Hereinabove, although one embodiment has been described by a limited Example, one embodiment has been provided only for assisting in a more general understanding of one embodiment. Therefore, one embodiment is not limited to the Examples. Various modifications and changes may be made by those skilled in the art disclosed in the present specification from this description.

Therefore, the spirit disclosed in the present specification should not be limited to the described embodiments, but the claims and all modifications equal or equivalent to the claims are intended to fall within the spirit disclosed in the present specification.

1. A polyamideimide film-forming composition comprising:
polyamic acid or polyamideimide including a diamine-derived structural unit, a dianhydride-derived structural unit, and a diacid dichloride-derived structural unit; and
an additive,
wherein the additive contains inorganic nanoparticles, a polyfunctional (meth)acrylic compound, and one or more of blue-based pigments and dyes,
the inorganic nanoparticles are contained in an amount of 5 wt % to 40 wt % with respect to a solid content in the polyamic acid or the polyamideimide,
the polyfunctional (meth)acrylic compound is contained in an amount of 2 wt % to 10 wt % with respect to the solid content in the polyamic acid or the polyamideimide, and
the diamine-derived structural unit includes a structural unit derived from a compound represented by the following Chemical Formula 1, the dianhydride-derived structural unit includes a structural unit derived from a compound represented by the following Chemical Formula 2, and the diacid dichloride-derived structural unit includes a structural unit derived from one or more of a compound represented by the following Chemical Formula 3 and a compound represented by the following Chemical Formula 4:

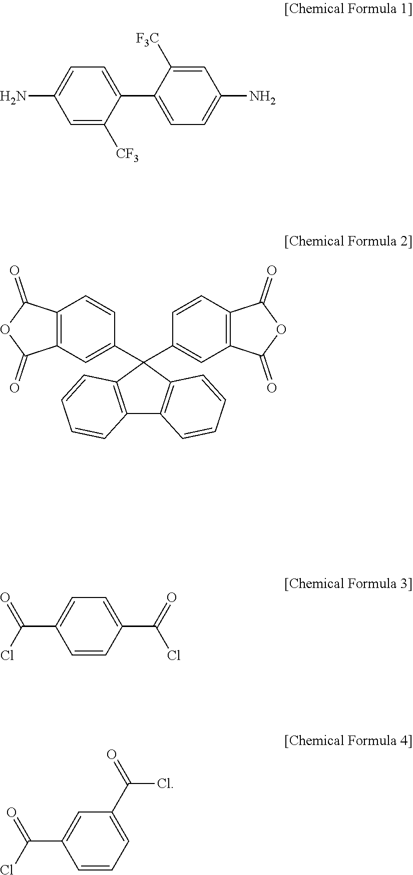

2. The polyamideimide film-forming composition of claim 1, wherein the inorganic nanoparticles are formed of silica, zirconium oxide, titanium oxide, zinc oxide, zinc sulfide, chromium oxide, barium titanate, or a combination thereof.

3. The polyamideimide film-forming composition of claim 1, wherein an average diameter of the inorganic nanoparticles is 5 nm to 50 nm.

4. The polyamideimide film-forming composition of claim 1, wherein the polyfunctional (meth)acrylic compound includes trimethylolpropane tri(meth)acrylate, trimethylolethane tri(meth)acrylate, 1,2,4,5-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa(meth)acrylate, polyfunctional urethane (meth)acrylate, polyfunctional polyester (meth)acrylate, or a combination thereof.

5. The polyamideimide film-forming composition of claim 1, wherein the polyfunctional (meth)acrylic compound further includes an alkylene group, an ether group, a urethane group, an ester group, or a combination thereof.

6. The polyamideimide film-forming composition of claim 1, wherein a maximum absorption wavelength of the blue-based pigment or dye is 520 nm to 650 nm.

7. The polyamideimide film-forming composition of claim 1, wherein the pigment is an inorganic pigment containing natural minerals; or one or more metals selected from zinc, titanium, lead, iron, copper, chromium, cobalt, molybdenum, manganese, and aluminum, or metal oxides thereof.

8. The polyamideimide film-forming composition of claim 1, wherein the polyamideimide film-forming composition satisfies the following Expression 1:
5,000≤V_{PAI}≤40,000 [Expression 1]
wherein
V_{PAI} is a viscosity of the polyamideimide film-forming composition when a solid content in the polyamic acid or the polyamideimide is 14 wt % with respect to a total weight of the polyamideimide film-forming composition, and the viscosity is a viscosity (unit: cp) measured at 25° C. with a Brookfield rotational viscometer using a 52Z spindle based on a torque of 80% and a time of 2 minutes.

9. The polyamideimide film-forming composition of claim 1, wherein when the diacid dichloride-derived structural unit includes a structural unit derived from any one of a compound represented by the following Chemical Formula 3 and a compound represented by the following Chemical Formula 4, the diacid dichloride-derived structural unit is included in an amount of 5 mol % to 50 mol % with respect to 100 mol % of the diamine-derived structural unit.

10. The polyamideimide film-forming composition of claim 1, wherein when the diacid dichloride-derived structural unit includes structural units derived from a compound represented by Chemical Formula 3 and a compound represented by Chemical Formula 4, the structural unit derived from the compound represented by Chemical Formula 3 is included in an amount of more than 50 mol % and less than 90 mol % with respect to a total of 100 mol % of the structural units derived from the compound represented by Chemical Formula 3 and the compound represented by Chemical Formula 4.

11. The polyamideimide film-forming composition of claim 1, wherein a molar ratio of the dianhydride-derived structural unit and the diacid dichloride-derived structural unit is 5:95 to 95:5.

12. A method of preparing a polyamideimide film-forming composition, the method comprising the steps of:
preparing a reaction product of a diamine and a diacid dichloride;
preparing a polyamic acid solution by adding the reaction product of the diamine and the diacid dichloride and a dianhydride to a reaction medium containing one or more of blue-based pigments and dyes and allowing a reaction to proceed; and
adding, to the polyamic acid solution, inorganic nanoparticles in an amount of 5 wt % to 40 wt % with respect to a solid content in polyamic acid or polyamideimide and a polyfunctional (meth)acrylic compound in an amount of 2 wt % to 10 wt % with respect to the solid content in the polyamic acid or the polyamideimide,
wherein the diamine contains a compound represented by the following Chemical Formula 1, the dianhydride contains a compound represented by the following Chemical Formula 2, and the diacid dichloride contains one or more of a compound represented by the following Chemical Formula 3 and a compound represented by the following Chemical Formula 4:

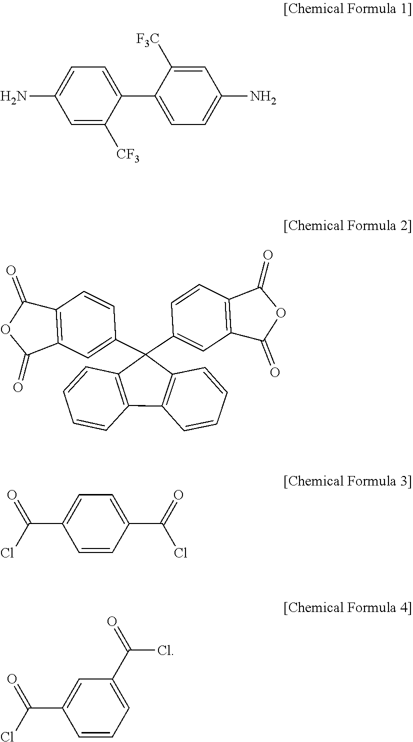 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

13. The method of claim 12, wherein the preparing of the reaction product of the diamine and the diacid dichloride includes preparing a diamine solution by mixing a diamine containing a compound represented by Chemical Formula 1 and a solvent, and then adding a diacid dichloride containing one or more of a compound represented by Chemical Formula 3 and a compound represented by Chemical Formula 4 to the diamine solution and allowing a reaction to proceed.

14. The method of claim 12, further comprising, after the preparing of the polyamic acid solution, adjusting a viscosity by adding an organic solvent to satisfy the following Expression 1:
5,000≤V_{PAI}≤40,000 [Expression 1]
wherein
V_{PAI} is a viscosity of the polyamideimide film-forming composition when a solid content in the polyamic acid or the polyamideimide is 14 wt % with respect to a total weight of the polyamideimide film-forming composition, and the viscosity is a viscosity (unit: cp) measured at 25° C. with a Brookfield rotational viscometer using a 52Z spindle based on a torque of 80% and a time of 2 minutes.

15. A polyamideimide film obtained by curing the polyamideimide film-forming composition of claim 1.

16. The polyamideimide film of claim 15, wherein an elongation at break of the polyamideimide film is 10% or more, and an absolute value of a thickness direction retardation (Rth) of the polyamideimide film is 950 nm or less when measured at a wavelength of 550 nm.

17. The polyamideimide film of claim 15, wherein a thickness of the polyamideimide film is 20 μm to 500 μm, and a yellow index (YI) of the polyamideimide film is 3.5 or less when measured according to ASTM E313.

18. A cover window for a display device comprising:
the polyamideimide film of claim 15; and
a coating layer disposed on the polyamideimide film.

19. The cover window for a display device of claim 18, wherein the coating layer is a hard coating layer, an antistatic layer, an anti-fingerprint layer, an anti-fouling layer, an anti-scratch layer, a low-refractive layer, an anti-reflective layer, an impact absorption layer, or a combination thereof.

20. A display device comprising the polyamideimide film of claim 15.
